(19) United States
(12) Patent Application Publication
(10) Pub. No.: US 2024/0352855 A1
(43) Pub. Date: Oct. 24, 2024

(54) Pulsed Neutron Determination of Borehole Fluid Hold-Up

(71) Applicant: Weatherford Technology Holdings, LLC, Houston, TX (US)

(72) Inventors: Natasa Mekic, Spring, TX (US); Richard Pemper, Sugar Land, TX (US); Gregory Schmid, Sugar Land, TX (US)

(21) Appl. No.: 18/302,502

(22) Filed: Apr. 18, 2023

(51) Int. Cl. E21B 49/08; G01V 5/10

(52) U.S. Cl. CPC E21B 49/087; E21B 49/00; G01V 5/102; E21B 2200/20; E21B 2200/22

(57) ABSTRACT

Methods, tools, and systems for determining two-phase borehole fluid holdup using pulsed neutron (PN) measurements are described. Embodiments of the techniques involve using formation models that are extended/extrapolated (or remodeled) to a value of 100 p.u., which correlates to the borehole environment where there is no formation matrix present. Those models can be used to determine the fractional relationship of oil and water in the borehole based on carbon and oxygen ratios provided by the PN measurement.

### FIELD OF THE INVENTION

The present application relates to logging of boreholes in underground formations (reservoirs), and more particularly, to pulsed-neutron measurements to determine borehole fluid hold-up.

### INTRODUCTION

Borehole fluid hold-up refers to the fractional relationship of various fluids within the borehole of an oil or gas well. This disclosure primarily relates to two-phase borehole fluid hold-up, which refers to the fractional relationship between oil and water within the wellbore. Water production often increases as oil reserves are depleted, or in response to a water injection program.

Another reason for measuring borehole fluid hold-up is to provide information for correcting measurements of formation properties by accounting for borehole effects in those measurements. For example, as explained in more detail below, pulsed neutron (PN) logging is commonly used to evaluate formation properties, such as carbon and water saturation within the pores of the formation. However, such logging measurements are often confounded by fluids in the borehole. Accurate knowledge of borehole hold-up can be used to correct for the borehole effects contained in those measurements.

Various methods may be used to calculate the fractional percentages, or “holdups,” of a phase component in the fluid flow. At a particular depth, the holdup of a specified phase (e.g., oil, or water) is defined as the fraction of the cross sectional area of the casing or tubing that is occupied by that phase. Traditional holdup logging devices include radioactive fluid-density (gamma-gamma attenuation) and the water-holdup (capacitance, or dielectric) tools. In addition, it is known to use a gradiomanometer, a device which measures pressure gradient over a given height, which gradient may be considered as being a function solely of the difference in level between the two measurement points and of the apparent density of the fluid. Given the respective densities of the various phases, it is then possible to calculate the various proportions thereof. Another approach consists in taking measurements by means of local sensors that produce signals having different levels depending on which phase is in contact with the sensor. Examples include resistivity-based sensors fiber optic type sensors by measuring optical reflectance.

PN measurements have also been used to determine borehole fluid hold-up. Such PN techniques rely on modeling, e.g., Monte Carlo N-Particle (MCNP) modeling of the environments that are to be measured. The MCNP models may be designed in various ways having various complexities, which impact how they can be implemented into particular workflows. There is a need in the art for further techniques for determining borehole fluid hold up based on PN logging.

### SUMMARY

Disclosed herein are methods of for determining a fractional relationship of oil and water in a borehole traversing a formation using a pulsed neutron (PN) tool deployable in the borehole, wherein the PN tool comprises a source configured to issue bursts of fast neutrons, thereby irradiating the borehole and the formation with neutrons, and at least one detector configured to detect gamma photons resulting from the irradiating and arriving at the detector, the methods comprising: (i) receiving data from a first of the at least one of the detectors, wherein the data comprises: carbon gamma photon counts indicative of gamma photons arising from inelastic interactions of the neutrons with carbon in the borehole, and oxygen gamma photon counts indicative of gamma photons arising from inelastic interactions of the neutrons with oxygen in the borehole, (ii) measuring a C/O ratio indicative of a ratio of the carbon gamma photon counts to the oxygen gamma photon counts, and (iii) using the measured C/O ratio to determine the fractional relationship of oil and water in a borehole. According to some embodiments, using the measured C/O ratio to determine the fractional relationship of oil and water in a borehole comprises interpolating the measured C/O ratio between a predicted C/O ratio corresponding to 100% oil saturation in the borehole and a predicted C/O ratio corresponding to 100% water saturation in the borehole. According to some embodiments, the methods further comprise calculating the predicted C/O ratio corresponding to 100% oil saturation in the borehole and the predicted C/O ratio corresponding to 100% water saturation in the borehole. According to some embodiments, calculating the predicted C/O ratio corresponding to 100% oil saturation in the borehole comprises calculating a predicted C/O ratio for 100% oil saturation at a formation porosity of at least 90 p.u., for example 100 porosity units (p.u.), and calculating the predicted C/O ratio corresponding to 100% water saturation in the borehole comprises calculating a predicted C/O ratio of 100% water saturation at a formation porosity of at least 90 p.u., for example 100 p.u. According to some embodiments, calculating the predicted C/O ratio for 100% oil saturation at a formation porosity of 100 p.u. comprises: using a first formation model to predict a first plurality of C/O ratios for 100% oil saturation in pores of the formation, wherein each of the first plurality of C/O ratios correspond to a different modeled formation porosity, wherein the modeled formation porosities range from 0 p.u. to 50 p.u. or less, and wherein the borehole is filled with oil, using the first plurality of C/O ratios to establish a 100% oil saturation line over the range of modeled formation porosities, and extrapolating the first 100% oil saturation line to a formation porosity of 100 p.u. According to some embodiments, calculating a predicted C/O ratio for 100% water saturation at a formation porosity of 100 p.u. further comprises: using a second formation model to predict a second plurality of C/O ratios for 100% water saturation in pores of the formation, wherein each of the second plurality of C/O ratios correspond to a different modeled formation porosity, wherein the modeled formation porosities range from 0 p.u. to 50 p.u. or less, and wherein the borehole is filled with water, using the second plurality of C/O ratios to establish a 100% water saturation line over the range of modeled formation porosities, and extrapolating the 100% water saturation line to a formation porosity of 100 p.u. According to some embodiments, calculating the predicted C/O ratio for 100% oil saturation at a formation porosity of 100 p.u. further comprises normalizing the extrapolated first 100% oil saturation line with respect to the extrapolating the 100% water saturation line. According to some embodiments, the predicted C/O ratio for 100% oil saturation at a formation porosity of 100 p.u. is determined from the extrapolated 100% water saturation line at a formation porosity of 100 p.u. According to some embodiments, the predicted C/O ratio for 100% water saturation at a formation porosity of 100 p.u. is determined from the extrapolated first 100% oil saturation line at a formation porosity of 100 p.u. According to some embodiments, the methods further comprise repeating steps (i)-(iii) for a plurality of depths over an interval of the borehole and generating a depth log of the fractional relationship of oil and water in the borehole over the interval. Also disclosed herein are non-transitory computer readable media comprising instructions, which, when executed on a computer, configure the computer for executing any of the above methods.

Also disclosed herein is a system of for determining a fractional relationship of oil and water in a borehole traversing a formation using a pulsed neutron (PN) tool deployable in the borehole, wherein the PN tool comprises a source configured to issue bursts of fast neutrons, thereby irradiating the borehole and the formation with neutrons, and at least one detector configured to detect gamma photons resulting from the irradiating and arriving at the detector, the system comprising: a non-transitory computer readable storage medium comprising instructions, which when executed by a computer configure the computer to perform a method comprising: (i) receiving data from a first of the at least one of the detectors, wherein the data comprises: carbon gamma photon counts indicative of gamma photons arising from inelastic interactions of the neutrons with carbon in the borehole, and oxygen gamma photon counts indicative of gamma photons arising from inelastic interactions of the neutrons with oxygen in the borehole, (ii) measuring a C/O ratio indicative of a ratio of the carbon gamma photon counts to the oxygen gamma photon counts, and (iii) using the measured C/O ratio to determine the fractional relationship of oil and water in a borehole. According to some embodiments, using the measured C/O ratio to determine the fractional relationship of oil and water in a borehole comprises interpolating the measured C/O ratio between a predicted C/O ratio corresponding to 100% oil saturation in the borehole and a predicted C/O ratio corresponding to 100% water saturation in the borehole. According to some embodiments, the method further comprises calculating the predicted C/O ratio corresponding to 100% oil saturation in the borehole and the predicted C/O ratio corresponding to 100% water saturation in the borehole. According to some embodiments, calculating the predicted C/O ratio corresponding to 100% oil saturation in the borehole comprises calculating a predicted C/O ratio for 100% oil saturation at a formation porosity of 100 porosity units (p.u.), and calculating the predicted C/O ratio corresponding to 100% water saturation in the borehole comprises calculating a predicted C/O ratio of 100% water saturation at a formation porosity 100 p.u. According to some embodiments, calculating the predicted C/O ratio for 100% oil saturation at a formation porosity of 100 p.u. comprises: using a first formation model to predict a first plurality of C/O ratios for 100% oil saturation in pores of the formation, wherein each of the first plurality of C/O ratios correspond to a different modeled formation porosity, wherein the modeled formation porosities range from 0 p.u. to 50 p.u. or less, and wherein the borehole is filled with oil, using the first plurality of C/O ratios to establish a 100% oil saturation line over the range of modeled formation porosities, and extrapolating the first 100% oil saturation line to a formation porosity of 100 p.u. According to some embodiments, calculating a predicted C/O ratio for 100% water saturation at a formation porosity of 100 p.u. further comprises: using a second formation model to predict a second plurality of C/O ratios for 100% water saturation in pores of the formation, wherein each of the second plurality of C/O ratios correspond to a different modeled formation porosity, wherein the modeled formation porosities range from 0 p.u. to 50 p.u. or less, and wherein the borehole is filled with water, using the second plurality of C/O ratios to establish a 100% water saturation line over the range of modeled formation porosities, and extrapolating the 100% water saturation line to a formation porosity of 100 p.u. According to some embodiments, calculating the predicted C/O ratio for 100% oil saturation at a formation porosity of 100 p.u. further comprises normalizing the extrapolated first 100% oil saturation line with respect to the extrapolating the 100% water saturation line. According to some embodiments, the predicted C/O ratio for 100% oil saturation at a formation porosity of 100 p.u. is determined from the extrapolated 100% water saturation line at a formation porosity of 100 p.u. According to some embodiments, the predicted C/O ratio for 100% water saturation at a formation porosity of 100 p.u. is determined from the extrapolated first 100% oil saturation line at a formation porosity of 100 p.u. According to some embodiments, the method further comprises repeating steps (i)-(iii) for a plurality of depths over an interval of the borehole and generating a depth log of the fractional relationship of oil and water in the borehole over the interval.

### BRIEF DESCRIPTION OF THE DRAWINGS

FIG. 1 shows an embodiment of a pulsed neutron (PN) logging tool.

FIG. 2 shows interactions of fast neutrons.

FIG. 3 shows PN modeling for calculating formation oil/water saturation.

FIG. 4 shows an embodiment of a workflow for calculating borehole fluid hold-up using PN measurements.

FIG. 5 shows PN modeling extended to 100 p.u.

FIGS. 6A and 6B show normalizing of PN modeling.

FIG. 7 shows PN modeling for determining borehole fluid hold-up using PN measurements.

FIG. 8 shows a log of two-phase fluid holdup for a borehole.

### DETAILED DESCRIPTION

Embodiments of the disclosure relate to methods and systems for using pulsed neutron (PN) logging to determine two-phase borehole fluid hold-up. PN logging is commonly used in the oil and gas industry for measuring a variety of characteristics within a formation penetrated by a wellbore. PN logging can be used to gain information about the borehole and surrounding formation, such as, saturation from carbon-oxygen (C/O) ratio, porosity, sigma value of the formation, pore fluid density, and many other properties.

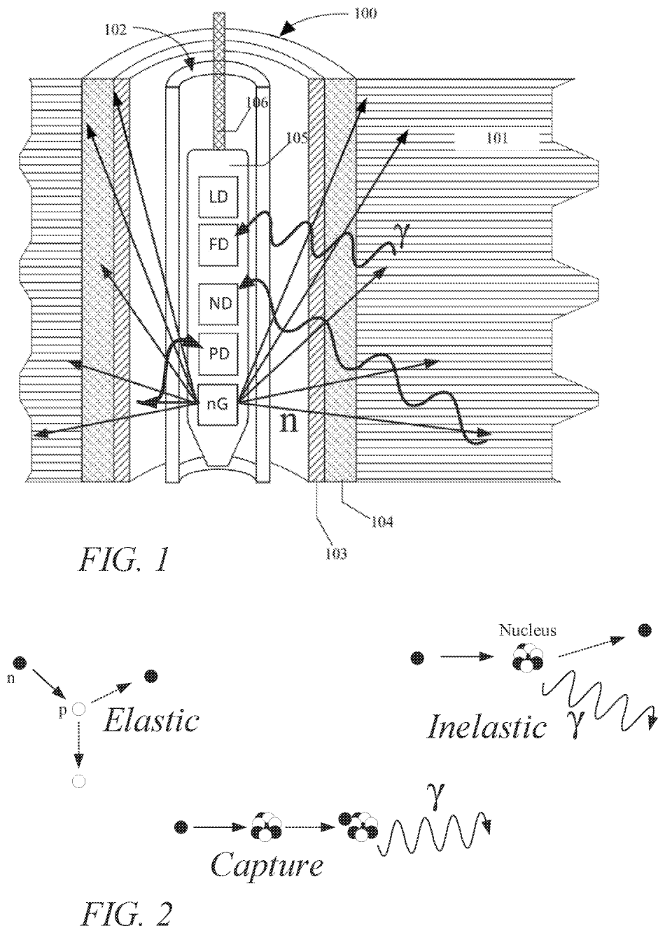

FIG. 1 illustrates some aspects of PN logging in a cased wellbore 100. The illustrated wellbore 100 is cased with a casing 103, which is cemented into the formation 101 by cement 104. The wellbore is equipped with a tubing string 102. A PN logging tool 105 is lowered into the tubing 102 using a wireline 106. The wireline 106 supports the weight of the tool and acts as a data conduit between the tool and processing capabilities at the surface. While the tool 105 is illustrated as being conveyed via wireline, it will be understood that the tool could also be conveyed into the wellbore in other ways such as via coiled tubing, drill string (e.g., during a logging while drilling operation), etc. According to some embodiments, the tool may be run as part of a logging string that includes the spectral gamma ray, density, and neutron porosity tools. The pulsed neutron logging tool 105 includes a neutron generator nG (e.g., a pulsed neutron generator), and one or more gamma-ray detectors, labeled here as PD (prox detector), ND (near detector), FD (far detector), and LD (long detector) in FIG. 1. According to some embodiments, the detector(s) may be lanthanum bromide (LaBr₃) gamma ray detectors (i.e., one or more photomultiplier tubes (PMTs) equipped with LaBr₃ scintillation materials). Lanthanum bromide doped with cesium LaBr₃ (Ce) can provide excellent performance for a nuclear spectroscopy system due to its outstanding properties, which include its elevated density (5.08 g/cm3 density), high resolution, and its ultra-fast decay time (16 nanoseconds). Note that the methods and tools described in this disclosure are not limited to logging tools with four detectors and can be used in any tool with at least one detector. Likewise, the methods and tools are not limited to cased wellbores and may be used in open hole scenarios as well.

During a pulsed neutron measurement, the neutron generator nG generates neutrons, which are released from the pulsed neutron logging tool 105 at about 14 MeV. The neutrons are represented as straight arrows labeled n in FIG. 1. The high-energy neutrons can undergo a variety of interactions with matter in the tubing 102, the casing 103, the cement 104, the formation 101, and also the fluids in the tubing and casing. Many of those interactions result in gamma photons that can be detected by the gamma detectors. Gamma photons are represented in FIG. 1 by wavy lines.

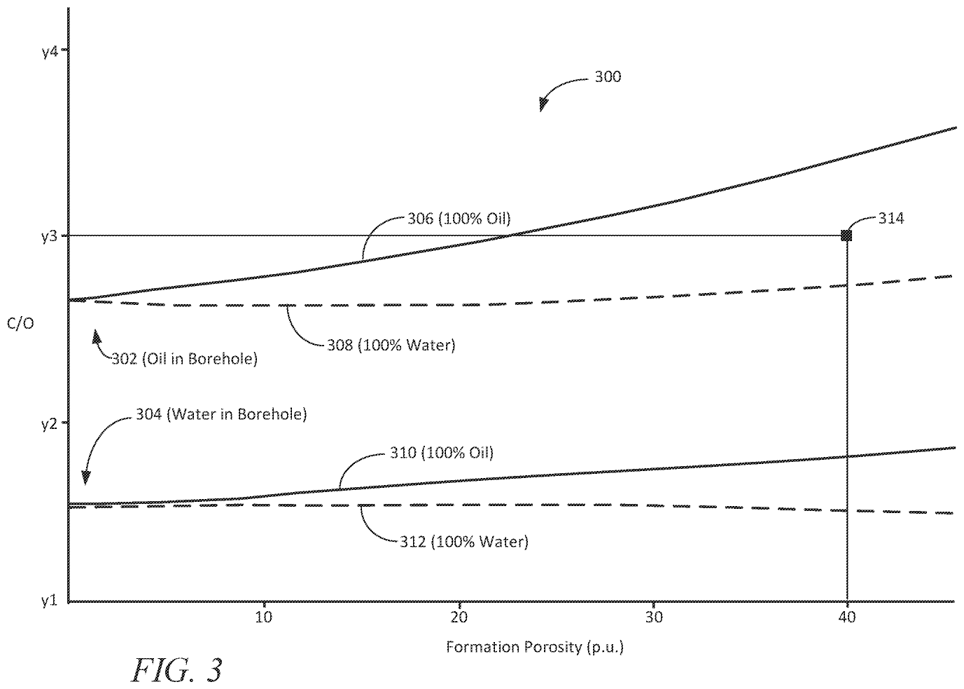

FIG. 2 illustrates three types of such interactions. One possible interaction is an elastic collision, also called elastic scattering, between a neutron n and a nucleus. In the illustrated example, the neutron n collides with a hydrogen nucleus, which consists of a single proton p. Hydrogen is omnipresent in most boreholes and formations due to the borehole and pore spaces of the formation typically being filled with liquid or gaseous hydrocarbons or water. In the elastic scattering process, the neutron n imparts some of its energy to the proton p, causing the proton to gain energy and the neutron to lose energy (i.e., to slow down). Hydrogen has a low molecular weight and absorbs a large fraction of the neutron energy in each scattering, thereby playing a major role in the slowing down of fast neutrons. It is well known in the art that the liquid-filled porosity can be inferred by measuring the slowing down distance of fast neutrons.

In an inelastic collision, also called inelastic scattering, a neutron collides with a nucleus, imparting a portion of the neutron's energy to the nucleus. The neutron exits the collision with less energy than before. The energy that is transferred to the nucleus excites the nucleus, which subsequently emits a gamma (1) photon when the nucleus relaxes. Nuclei of different atoms emit gamma photons having different energies. Therefore, the energy of the emitted gamma photon is indicative of the type of nucleus involved in an inelastic collision. In other words, an energy spectrum of detected gamma photons will contain peaks corresponding to the particular atoms that gave rise to the detected gamma photons by participating in inelastic scattering events. Gamma photons arising from inelastic scattering are typically detected during the time that the neutron generator is actively emitting neutrons. In other words, inelastic events primarily occur during the “neutron burst.”

Notice that both elastic and inelastic scattering cause neutrons to lose energy. After a high energy neutron has undergone a number of collisions, its energy will be reduced. Neutrons having an energy above approximately 1 MeV are considered fast neutrons. Fast neutrons can trigger gamma rays due to inelastic scattering, as described above. Neutrons that are slowed to about 0.4 to 100 eV are considered “epithermal neutrons” and neutrons that are slowed to about 0.025 eV are referred to as “thermal neutrons.” Epithermal and thermal neutrons can participate in a third type of interaction whereby the thermal neutron is “captured” by the nucleus of an atom. The capturing nucleus becomes excited and emits a gamma photon when it relaxes. The nuclei of some atoms have a greater affinity to capture thermal neutrons than other nuclei. Again, the energy of the emitted gamma photons is indicative of the type of nucleus involved in a capture event. Accordingly, an energy spectrum of gamma photons arising from capture events will contain peaks indicative of the atoms that underwent the capture events. Gamma photons arising from capture events may be detected during the neutron burst as well as during the period after the neutron generator has stopped issuing neutrons.

As is well known in the art, many PN measurements involve first modeling how the particular PN tool is expected to respond under a variety of modeled borehole/casing configurations and porosities. An example of such modeling is Monte Carlo N-Particle (MCNP) modeling, which is familiar in the art (see, e.g., Cox, L. J. et al, MCNP version 5, Los Alamos National Laboratory, Los Alamos, N. Mex. (2002)). When the PN tool is run in a particular wellbore, the model may include specific characteristics of that particular wellbore, formation, etc. For example, the modeling may account for the particular casing size and weight, formation lithology, borehole and formation fluid density, salinity, production tubing strings and their content, drilling mud type, weight, and composition, etc. The modeling allows the user to correlate the data acquired by the PN tool to characteristics of interest for the particular subject wellbore/formation.

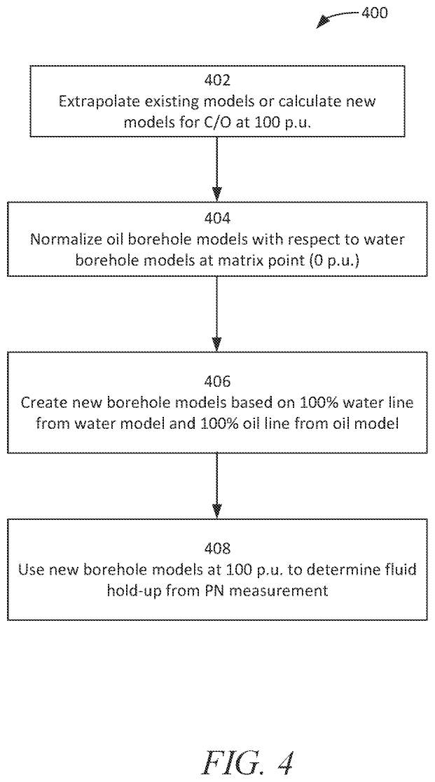

FIG. 3 illustrates an example of how modeling is used, in conjunction with PN data, to determine formation/wellbore properties. Specifically, FIG. 3 illustrates an embodiment for determining hydrocarbon and water saturation within the pores of a formation. Saturation measurements are commonly performed for tracking reservoir depletion, planning workover and enhancement strategies, and diagnosing production problems. In FIG. 3, a set of MCNP models 300 are used to predict a PN tool's response to carbon and oxygen under various conditions. For example, the MCNP models may predict the ratio of carbon inelastic gamma photon counts to oxygen inelastic photon counts (shown on the vertical axis) that will be detected at one of the gamma tool's gamma detectors under various conditions. The modeling is performed at different formation porosities (shown on horizontal axis) ranging from 0 porosity units (p.u.) up to about 45 p.u. Note that about 45 p.u. or about 50 p.u. is the highest porosity that is typically relevant to such measurements because most formations are not stable at higher porosities. The top pair of models 302 corresponds to a modeled scenario when the borehole contains only oil. The bottom pair of models 304 corresponds to a modeled scenario when the borehole contains only water. For each of the pairs of models, the top modeled line predicts the C/O ratio for a situation wherein the pores are completely saturated with hydrocarbon and the bottom modeled line predicts the C/O ratio for the situation when the pores are completely saturated with water. That is, model 306 predicts the tool's response to 100% oil-saturated pores when the borehole is filled with oil; model 308 predicts the tool's response to 100% water-saturated pores when the borehole is filled with oil; model 310 predicts the tool's response to 100% oil-saturated pores when the borehole is filled with water; and model 312 predicts the tool's response to 100% water-saturated pores when the borehole is filled with water.

Once a set of models, such as the models 300 are determined, they can be used to determine the saturation of a formation of known porosity. For example, assume that the user knows that the borehole is completely filled with oil and that the porosity of interrogated interval is 40 p.u. Also, assume that the PN tool determines a C/O measurement (point 314) of y2 (i.e., the number of C inelastic photon counts divided by the number of O inelastic photon counts equals y2). The user can interpolate the measured value of the C/O ratio between the predicted water saturation value and the predicted oil saturation value at the known porosity. Since the measured C/O value is about 40% of the distance between the modeled water saturation value and the modeled oil saturation value, the models predict that the measured C/O value corresponds to the pores being 60% saturated with water and 40% saturated with oil.

The inventors have discovered that models, similar to the models 300 illustrated in FIG. 3, can be extrapolated or extended (e.g., from preexisting models) or can be remodeled to a porosity of 100 p.u. (i.e., 100% porosity), and used to calculate borehole two-phase hold-up. In other words, the models 300 can be modified and/or further processed to predict the tool's response to the fractional relationship between water and oil in the borehole itself. Accordingly, aspects of this disclosure relate to extrapolating the models to a high porosity, for example, to at least 90 p.u., and typically to 100 p.u.

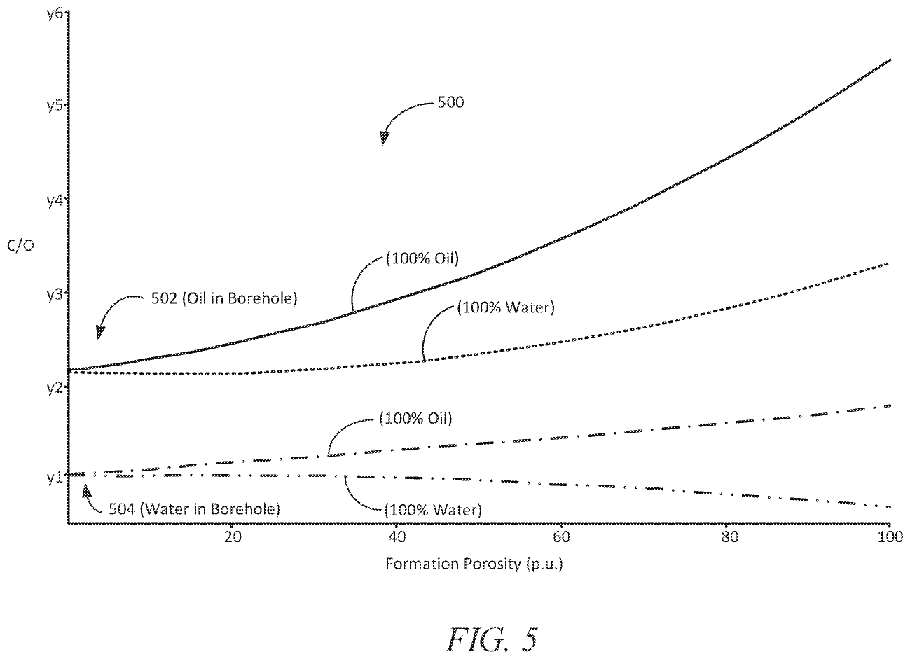

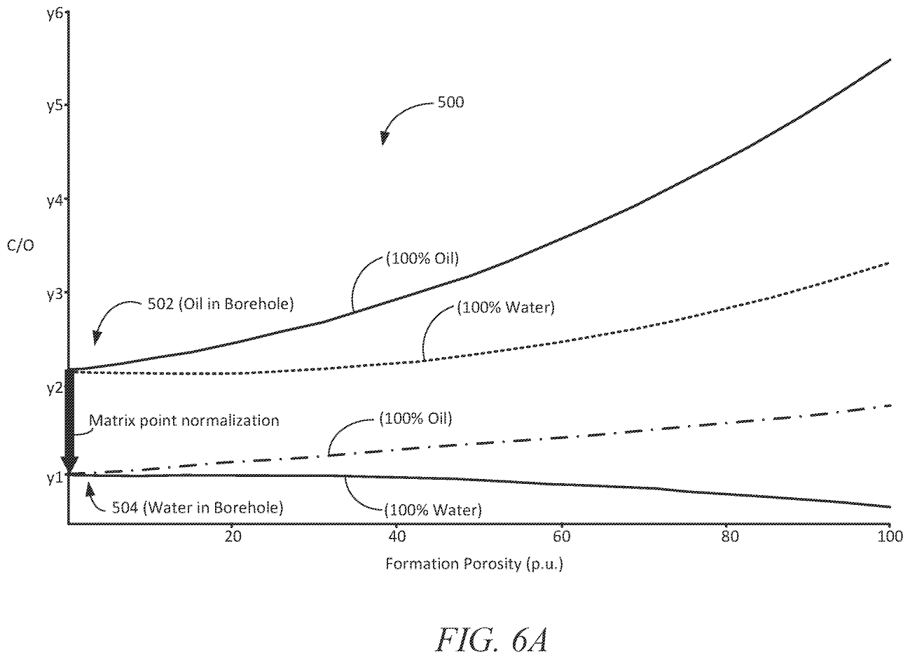

FIG. 4 illustrates an example workflow 400 for using PN measurements for determining borehole two-phase hold-up. Step 402 of the workflow comprises extrapolating the predicted oil-saturation lines and water-saturation lines of the existing models (such as the models 302 and 304, FIG. 3) to establish the lines out to a porosity of 100 p.u. Alternatively, new models may be determined for the tool's responses to each of the saturation scenarios at 100 p.u. FIG. 5 illustrates a pair of models 502 for an oil-filled borehole (one for 100% oil saturation and one for 100% water saturation) and another pair of models 504 (one for 100% oil saturation and one for 100% water saturation). The lines of each of the models extend all the way to a 100% formation porosity. A person of skill in the art will understand that a porosity of 100 p.u. denotes open space (i.e., no matrix). Accordingly, the space within the borehole may be described as having a porosity of 100 p.u. The lines corresponding to each of the models are shown using different dash patterns for reasons that will become apparent below.

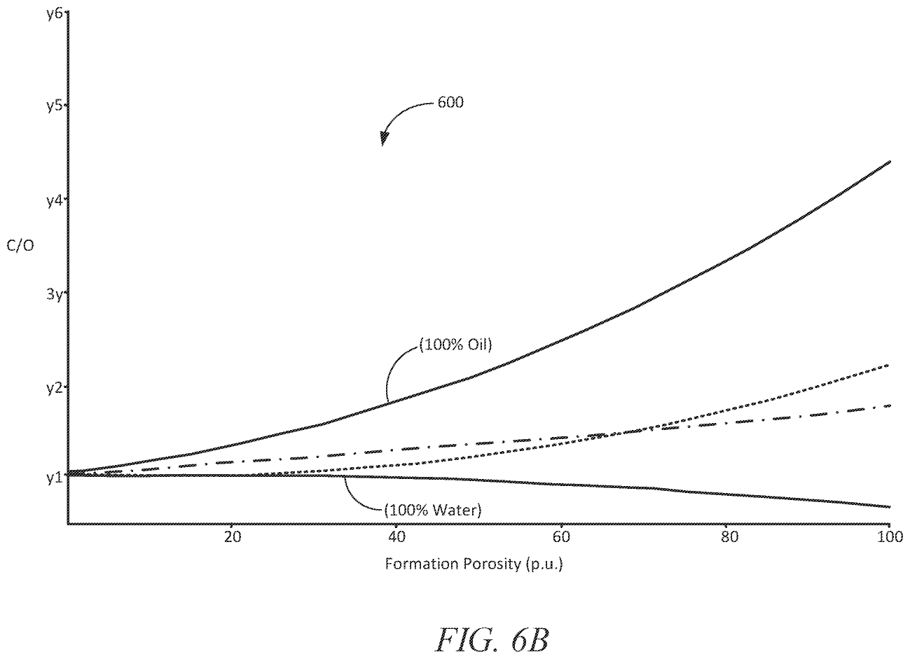

Referring again to the workflow 400 (FIG. 4), step 404 comprises normalizing the models for the oil-filled borehole with respect to the models for the water-filled borehole. This normalization is performed at the matrix point, i.e., the point in each of the models corresponding to 0 p.u. The normalization is graphically illustrated in FIGS. 6A and 6B. As shown in FIG. 6A, the normalization comprises determining an offset between the predicted C/O values oil-filled borehole and the predicted C/O values for the water-filled borehole at the matrix point. That offset is then subtracted from each of the predicted C/O values determined for the oil-filled model at each of the porosity. FIG. 6B shows the normalized set of models 600.

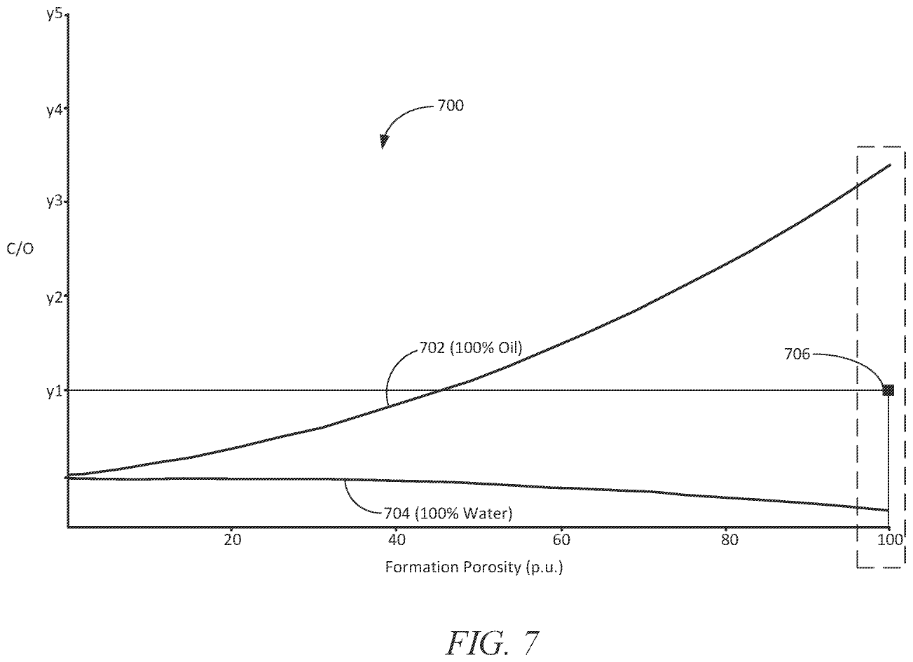

Referring again to FIG. 4, step 406 comprises determining new borehole models based on the normalized models (i.e., the normalized models as shown in FIG. 6B). FIG. 7 shows a pair 700 of new borehole models arrived at from the process described above. The new predicted oil-saturation values (100% oil line) 702 comprise the normalized oil-saturation values. The predicted water saturation values (100% water line) 704 simply comprise the original water saturation values obtained for the water-filled borehole, as those values do not change during the normalization procedure.

Referring again to the workflow 400 (FIG. 4), step 408 comprises using the new borehole models to determine fluid hold-up based on data from the PN tool. According to some embodiments, this determination comprises using the predicted saturation values of the new borehole models 702 and 704 at 100 p.u. Again, since 100 p.u. corresponds to a situation in which no matrix exists, the environment within the borehole can be considered as corresponding to a porosity value of 100 p.u. Referring to FIG. 7, assume that the PN tool obtains a C/O ratio measurement 706 at a given depth of C/O=y1. The measured C/O value can be interpolated between the predicted 100% water saturation value and the predicted 100% oil saturation value at 100 p.u to yield the fractional composition of water and oil within the borehole. Since that measured value is about one-third between the predicted 100% water value and the predicted 100% oil value at 100 p.u., the determined borehole fluid hold-up is about two-thirds water and one-third oil.

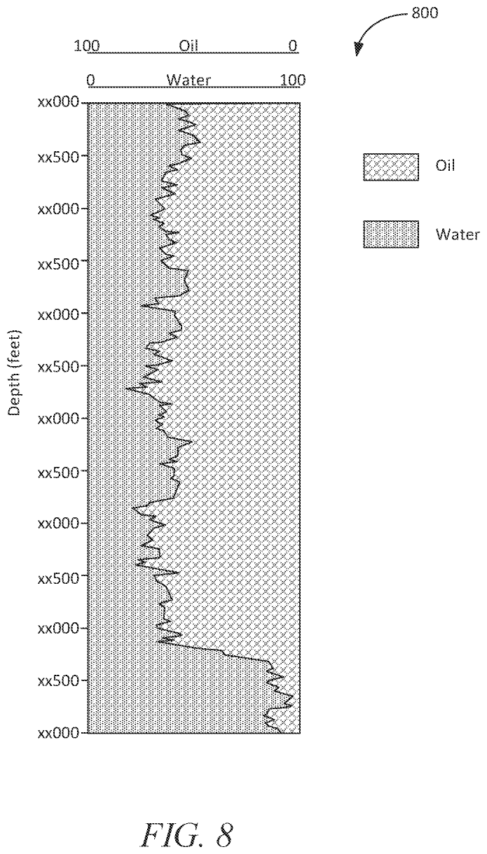

The described process for determining borehole fluid hold-up may be repeated at various depths as the PN tool is conveyed within the borehole to generate a depth log of the hold-up. FIG. 8 illustrates an example of a hold-up log 800. Notice that in the upper portion of the log, the borehole fluid hold-up is about 50% oil and 50% water, but the lowest portion comprises only about 10-20% oil.

A person of skill in the art will appreciate that embodiments of the above-described techniques estimate a borehole fluid holdup by modeling the borehole as a space having a “formation porosity” of 100 p.u. That is, the techniques assume no presence of matrix (which holds true within the borehole). However, as a person of skill in the art will understand, the detector will likely detect some photons originating by events arising within the formation. The formation effects can be minimized by using a detector that is close to the neutron generator. The formation effects will also be more prevalent in smaller boreholes compared to larger ones.

Some portions of the detailed description were presented in terms of processes, methods, programs and workflows. A process or workflow is here, and generally, conceived to be a self-consistent sequence of steps (instructions) contained in memory and run using processing resources to achieve a desired result. The steps are those requiring physical manipulations of physical quantities. Usually, though not necessarily, these quantities take the form of electrical, magnetic or optical signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “receiving,” “calculating,” “determining,” “displaying,” or the like, refer to the action and processes of a computer system, or similar electronic computing device, that manipulates and transforms data represented as physical (electronic) quantities within the computer system memories or registers or other such information storage, transmission or display devices.

The present disclosure also relates to an apparatus for performing the operations herein. This apparatus may be specially constructed for the required purposes, or it may comprise a general-purpose computer, selectively activated or reconfigured by a computer program stored in the computer. Such a computer program may be stored in a non-transitory computer readable storage medium, which could be, but is not limited to, any type of disk including floppy disks, optical disks, CD-ROMs, a magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor, or may be architectures employing multiple processor designs for increased computing capability. Such processing resources may be configured within a PN tool, as described herein, or configured on the surface and configured to receive data from the PN tool. Data from the PN tool may be telemetered to the processing resources or may saved on computer readable storage and provided to the processing resources.

While the invention herein disclosed has been described in terms of specific embodiments and applications thereof, numerous modifications and variations could be made thereto by those skilled in the art without departing from the scope of the invention set forth in the claims.

What is claimed is:

1. A method of for determining a fractional relationship of oil and water in a borehole traversing a formation using a pulsed neutron (PN) tool deployable in the borehole, wherein the PN tool comprises a source configured to issue bursts of fast neutrons, thereby irradiating the borehole and the formation with neutrons, and at least one detector configured to detect gamma photons resulting from the irradiating and arriving at the detector, the method comprising:
(i) receiving data from a first of the at least one of the detectors, wherein the data comprises:
carbon gamma photon counts indicative of gamma photons arising from inelastic interactions of the neutrons with carbon in the borehole, and
oxygen gamma photon counts indicative of gamma photons arising from inelastic interactions of the neutrons with oxygen in the borehole,
(ii) measuring a C/O ratio indicative of a ratio of the carbon gamma photon counts to the oxygen gamma photon counts, and
(iii) using the measured C/O ratio to determine the fractional relationship of oil and water in a borehole.

2. The method of claim 1, wherein using the measured C/O ratio to determine the fractional relationship of oil and water in a borehole comprises interpolating the measured C/O ratio between a predicted C/O ratio corresponding to 100% oil saturation in the borehole and a predicted C/O ratio corresponding to 100% water saturation in the borehole.

3. The method of claim 2, further comprising calculating the predicted C/O ratio corresponding to 100% oil saturation in the borehole and the predicted C/O ratio corresponding to 100% water saturation in the borehole.

4. The method of claim 3, wherein
calculating the predicted C/O ratio corresponding to 100% oil saturation in the borehole comprises calculating a predicted C/O ratio for 100% oil saturation at a formation porosity of at least 90 porosity units (p.u.), and
calculating the predicted C/O ratio corresponding to 100% water saturation in the borehole comprises calculating a predicted C/O ratio of 100% water saturation at a formation porosity of at least 90 p.u.

5. The method of claim 3, wherein
calculating the predicted C/O ratio corresponding to 100% oil saturation in the borehole comprises calculating a predicted C/O ratio for 100% oil saturation at a formation porosity of 100 p.u., and
calculating the predicted C/O ratio corresponding to 100% water saturation in the borehole comprises calculating a predicted C/O ratio of 100% water saturation at a formation porosity of 100 p.u.

6. The method of claim 4, wherein calculating the predicted C/O ratio for 100% oil saturation at a formation porosity of at least 90 p.u. comprises:
using a first formation model to predict a first plurality of C/O ratios for 100% oil saturation in pores of the formation, wherein each of the first plurality of C/O ratios correspond to a different modeled formation porosity, wherein the modeled formation porosities range from 0 p.u. to 50 p.u. or less, and wherein the borehole is filled with oil,
using the first plurality of C/O ratios to establish a 100% oil saturation line over the range of modeled formation porosities, and
extrapolating the first 100% oil saturation line to a formation porosity of at least 90 p.u., and
wherein calculating the predicted C/O ratio for 100% water saturation at a formation porosity of at least 90 p.u. comprises:
using a second formation model to predict a second plurality of C/O ratios for 100% water saturation in pores of the formation, wherein each of the second plurality of C/O ratios correspond to a different modeled formation porosity, wherein the modeled formation porosities range from 0 p.u. to 50 p.u. or less, and wherein the borehole is filled with water,
using the second plurality of C/O ratios to establish a 100% water saturation line over the range of modeled formation porosities, and
extrapolating the 100% water saturation line to a formation porosity of at least 90 p.u.

7. The method of claim 6, wherein calculating the predicted C/O ratio for 100% oil saturation at a formation porosity of at least p.u. further comprises normalizing the extrapolated first 100% oil saturation line with respect to the extrapolating the 100% water saturation line.

8. The method of claim 7, wherein the predicted C/O ratio for 100% oil saturation at a formation porosity of at least 90 p.u. is determined from the extrapolated 100% water saturation line at a formation porosity of at least 90 p.u.

9. The method of claim 8, wherein the predicted C/O ratio for 100% water saturation at a formation porosity of at least 90 p.u. is determined from the extrapolated first 100% oil saturation line at a formation porosity of at least 90 p.u.

10. The method of claim 1, further comprising repeating steps (i)-(iii) for a plurality of depths over an interval of the borehole and generating a depth log of the fractional relationship of oil and water in the borehole over the interval.

11. A system of for determining a fractional relationship of oil and water in a borehole traversing a formation using a pulsed neutron (PN) tool deployable in the borehole, wherein the PN tool comprises a source configured to issue bursts of fast neutrons, thereby irradiating the borehole and the formation with neutrons, and at least one detector configured to detect gamma photons resulting from the irradiating and arriving at the detector, the system comprising:
a non-transitory computer readable storage medium comprising instructions, which when executed by a computer configure the computer to perform a method comprising:
(i) receiving data from a first of the at least one of the detectors, wherein the data comprises:
carbon gamma photon counts indicative of gamma photons arising from inelastic interactions of the neutrons with carbon in the borehole, and
oxygen gamma photon counts indicative of gamma photons arising from inelastic interactions of the neutrons with oxygen in the borehole,
(ii) measuring a C/O ratio indicative of a ratio of the carbon gamma photon counts to the oxygen gamma photon counts, and
(iii) using the measured C/O ratio to determine the fractional relationship of oil and water in a borehole.

12. The system of claim 11, wherein using the measured C/O ratio to determine the fractional relationship of oil and water in a borehole comprises interpolating the measured C/O ratio between a predicted C/O ratio corresponding to 100% oil saturation in the borehole and a predicted C/O ratio corresponding to 100% water saturation in the borehole.

13. The system of claim 12, wherein the method further comprises calculating the predicted C/O ratio corresponding to 100% oil saturation in the borehole and the predicted C/O ratio corresponding to 100% water saturation in the borehole.

14. The system of claim 13, wherein
calculating the predicted C/O ratio corresponding to 100% oil saturation in the borehole comprises calculating a predicted C/O ratio for 100% oil saturation at a formation porosity of at least 90 porosity units (p.u.), and
calculating the predicted C/O ratio corresponding to 100% water saturation in the borehole comprises calculating a predicted C/O ratio of 100% water saturation at a formation porosity of at least 90 p.u.

15. The system of claim 13, wherein
calculating the predicted C/O ratio corresponding to 100% oil saturation in the borehole comprises calculating a predicted C/O ratio for 100% oil saturation at a formation porosity of 100 porosity units (p.u.), and
calculating the predicted C/O ratio corresponding to 100% water saturation in the borehole comprises calculating a predicted C/O ratio of 100% water saturation at a formation porosity 100 p.u.

16. The system of claim 14, wherein calculating the predicted C/O ratio for 100% oil saturation at a formation porosity of 100 p.u. comprises:
using a first formation model to predict a first plurality of C/O ratios for 100% oil saturation in pores of the formation, wherein each of the first plurality of C/O ratios correspond to a different modeled formation porosity, wherein the modeled formation porosities range from 0 p.u. to 50 p.u. or less, and wherein the borehole is filled with oil,
using the first plurality of C/O ratios to establish a 100% oil saturation line over the range of modeled formation porosities, and
extrapolating the first 100% oil saturation line to a formation porosity of at least 90 p.u., and
wherein calculating the predicted C/O ratio for 100% water saturation at a formation porosity of 100 p.u. further comprises:
using a second formation model to predict a second plurality of C/O ratios for 100% water saturation in pores of the formation, wherein each of the second plurality of C/O ratios correspond to a different modeled formation porosity, wherein the modeled formation porosities range from 0 p.u. to 50 p.u. or less, and wherein the borehole is filled with water,
using the second plurality of C/O ratios to establish a 100% water saturation line over the range of modeled formation porosities, and
extrapolating the 100% water saturation line to a formation porosity of at least 90 p.u.

17. The system of claim 16, wherein calculating the predicted C/O ratio for 100% oil saturation at a formation porosity of at least 90 p.u. further comprises normalizing the extrapolated first 100% oil saturation line with respect to the extrapolating the 100% water saturation line.

18. The system of claim 17, wherein the predicted C/O ratio for 100% oil saturation at a formation porosity of at least 90 p.u. is determined from the extrapolated 100% water saturation line at a formation porosity of at least 90 p.u.

19. The system of claim 18, wherein the predicted C/O ratio for 100% water saturation at a formation porosity of at least 90 p.u. is determined from the extrapolated first 100% oil saturation line at a formation porosity of at least 90 p.u.

20. The system of claim 11, wherein the method further comprises repeating steps (i)-(iii) for a plurality of depths over an interval of the borehole and generating a depth log of the fractional relationship of oil and water in the borehole over the interval.
